(19) United States
(12) Patent Application Publication
(10) Pub. No.: US 2008/0063453 A1
(43) Pub. Date: Mar. 13, 2008

(54) Inkjet Printer with Double-Side Printing Function

(75) Inventors: Chin-Teng Huang, Hsinchu (TW); Huan-Hsing Hsiao, Hsinchu (TW); Chih-Ming Lin, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: FOXLINK IMAGE TECHNOLOGY CO., LTD., Hsinchu (TW)

(21) Appl. No.: 11/530,865

(22) Filed: Sep. 11, 2006

(51) Int. Cl. B41J 3/60

(52) U.S. Cl. 400/188

(57) ABSTRACT

An inkjet printer with double-side printing function includes a base, a guided component located in the base and a cover covered on the base and the guided component. A second path is located between the base and the guided component. A second path exit is located in the end of the second path, and a second path entrance is located in the front of the second path. A redirector is located nearby the second path exit. A first path is located between the base and the cover and between the guided component and the cover. The second path exit and the second path entrance pass through the first path. A print apparatus is located in the cover. The print apparatus has a print head. The print head is located between the printed driving roller and the second path entrance.

### BACKGROUND OF THE INVENTION

1. Field of the Invention

This present invention relates to an inkjet printer, and more specifically to an inkjet printer with double-side printing function.

2. The Related Art

Referring to FIG. 7, a traditional inkjet printer 100 with double-side printing function comprises a base 10, a guided component 50 located in the base 10 and a cover 30 covered on the base 10 and the guided component 50. A first path 101 is located between the base 10 and the cover 30 and between the guided component 50 and the cover 30. A second path 111 is located between the base 10 and the guided component 50. A second path entrance 112 is formed in the end of the second path 111, and a second path exit 113 is formed in the front of the second path 111. A redirecting portion 60 is set in the cross between the first path 101 and the second path exit 113. The redirecting portion 60 is used to separate or connect the first path 101.

An exit driving roller 503a is located in the front of the end of the base 10, an exit driven roller 503b is located in the cover 10 and match for the exit driving roller 503a. A deliverable driving roller 505a is located in the back of the exit driving roller 503a and match for a deliverable driven roller 505b which is located in the cover 30. A printed driving roller 504a is located in the back of the deliverable driving roller 505a and nearby the second path entrance 112, a printed driven roller 504b is located in the cover 30 and match for the printed driving roller 504a. A print apparatus 32 is located in the cover 30 and a print head 33 of the print apparatus 32 is situated between the printed driven roller 504b and deliverable driven roller 505b. While a paper S passes through the under of the print head 33, the facade of the paper S is printed by the print head 33.

Referring to FIGS. 8 and 9, while the paper S is delivered in the traditional inkjet printer 100 with double-side printing function, the end of the paper S is clamped between the printed driving roller 504a and the printed driven roller 504b. The printed driving roller 504a and the printed driven roller 504b are conversely revolving around their own axles, and the redirecting portion 60 separates the first path 101, the paper S is delivered into the second path 111. While the paper S is delivered from the second path 111 into the first path 101, the paper S passes through the under of the print head 33, the opposite side of the paper S is printed by the print head 33. Therefore the double sides of the paper S cannot be printed entirely by the traditional inkjet printer 100 with double-side printing function.

As shown as FIG. 8, while the paper S is delivered in the traditional inkjet printer 100 with double-side printing function, a part of the facade of the paper S having length L cannot be printed by the print head 33, as a result the facade of the paper S is not printed by the traditional inkjet printer 100 with double-side printing function. That is because the redirecting portion 60 and the second path 111 are placed behind the printing cartridge apparatus 32. Further due to the arrangement of roller sets for clamping the paper, there is a small part of the paper which is unable to be printed.

### SUMMARY OF THE INVENTION

An object of the invention is to provide an inkjet printer with double-side printing function comprising a base, a guided component located in the base and a cover covered on the base and the guided component. A shelf is located on the top of the back of the base. An exit driving roller is located on the top of the front of the base. A second path is formed between the guided component and the base, delivered driving rollers and delivered driven rollers are located along the second path. A second path exit is located in the front of the second path, and a second path entrance is located in the back of the second path. A printed driving roller is located nearby the exit of the second path and the top of the guided component. A redirecting driving roller is located in the second path entrance and the back of the exit driving roller. A first path is located between the base and the cover and between the guided component and the cover. The first path has a first path entrance in the end of the first path and a first path exit in the front of the first path. The first path entrance passes through the front of the shelf. The first path exit is located nearby the exit driving roller. The second path exit and the second path entrance are pass through the first path. A print apparatus is located in the cover. The print apparatus has a print head. A feeding roller is located in the back of the cover and corresponds to the shelf. An exit driven roller, a redirecting driven roller and a printed driven roller are located in the cover and correspond to the exit-driving roller, the redirecting driving roller and the printed driving roller respectively. The print head of the print apparatus is arranged between the redirecting driven roller and the printed driven roller. A redirector is located nearby the second path entrance. While the facade of a paper is printed by the print head, the paper is reversedly delivered along the first path, the redirector separates the first path, the paper passes through the second path entrance into the second path.

The second path entrance of the inkjet printer with double-side printing function is located in the front of the print head of the inkjet printer with double-side printing function. While the facade of the paper S is printed by the print head entirely, the paper S passes through the under of the print head completely, the paper S is reversedly delivered into the second path by the second path entrance in the front of the print head. The paper S is passed through into the first path by the second path, the opposite side of the paper S is printed by the print head. Therefore the double sides of the paper S is printed entirely by the present invention, an inkjet printer with double-side printing function.

### BRIEF DESCRIPTION OF THE DRAWINGS

The invention, together with its objects and the advantages thereof may be best understood by reference to the following description taken in conjunction with the accompanying drawings, in which:

FIG. 1 is a schematic illustration of an inkjet printer with double-side printing function according to the present invention;

FIG. 2 is a schematic illustration showing a paper being printed on one side;

FIG. 3 is a schematic illustration of the apparatus shown in FIG. 1 with a redirector which is pushed forward and revolved clockwise by the paper;

FIG. 4 is a schematic illustration of the apparatus shown in FIG. 1 with the paper passing through a first path into a second path;

FIG. 5 is a schematic illustration of the paper being delivered along the second path;

FIG. 6 is a schematic illustration showing the paper being printed on an opposite side;

FIG. 7 is a schematic illustration of a traditional inkjet printer with double-side printing function;

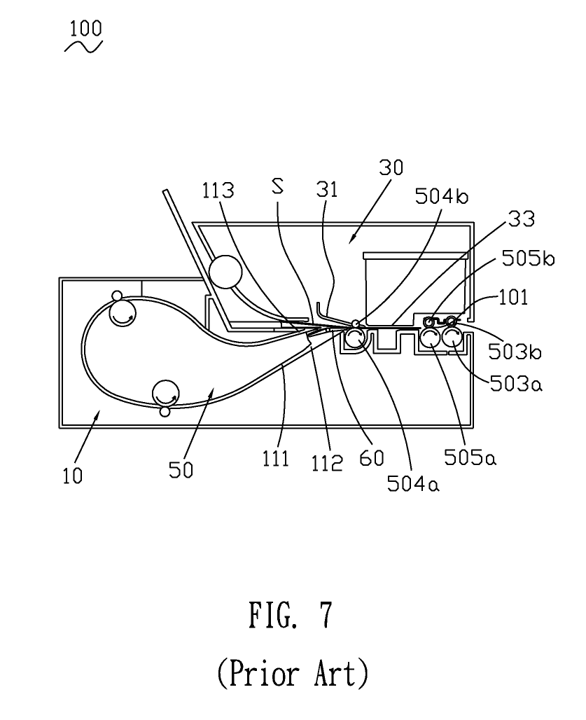

FIG. 8 is a schematic illustration of a paper be printed by the traditional inkjet printer with double-side printing function; and

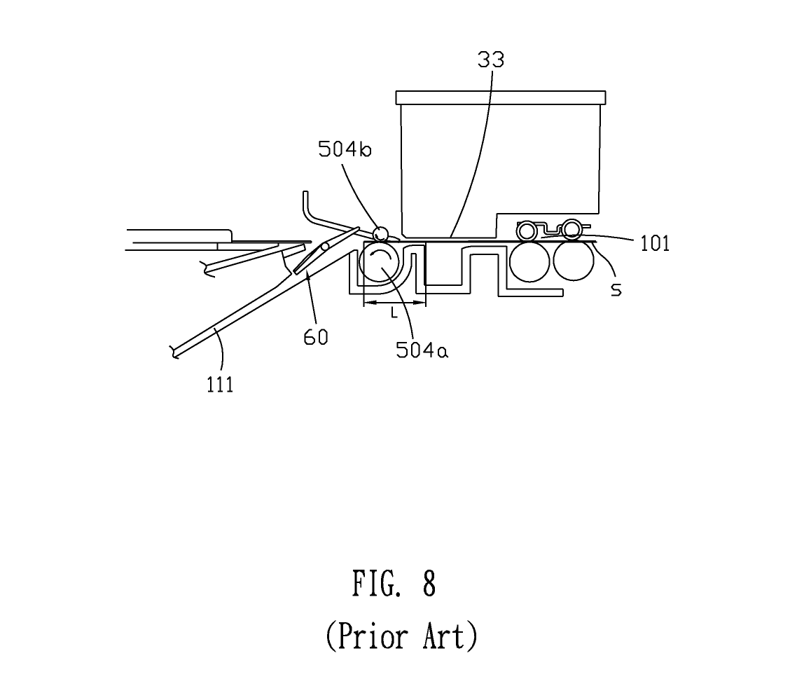

FIG. 9 is a schematic illustration of the paper passing through a second path entrance into a second path.

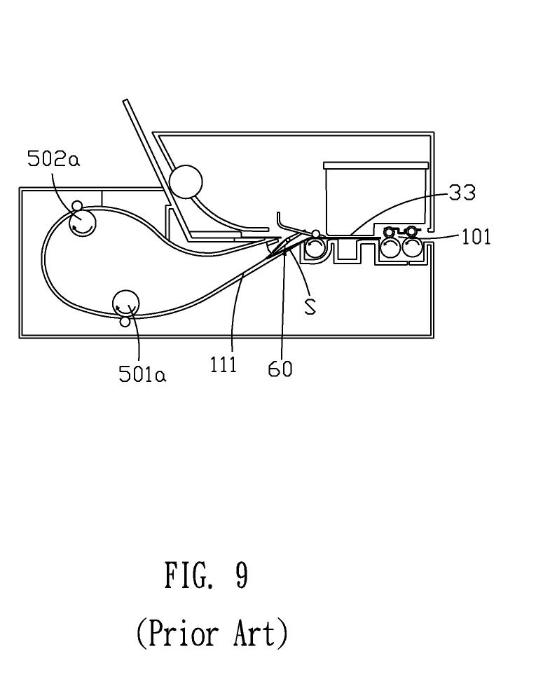

### DETAILED DESCRIPTION OF THE PREFERRED EMBODIMENT

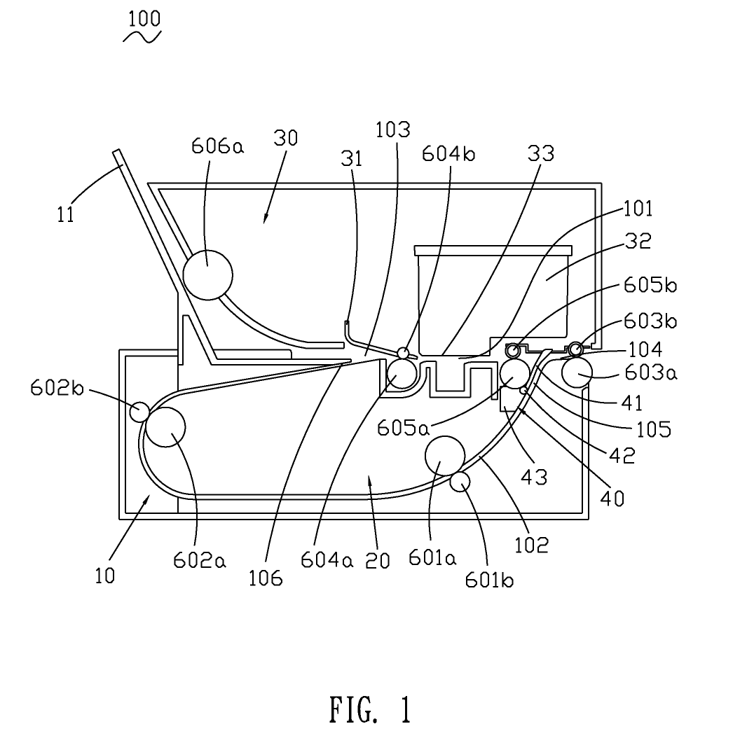

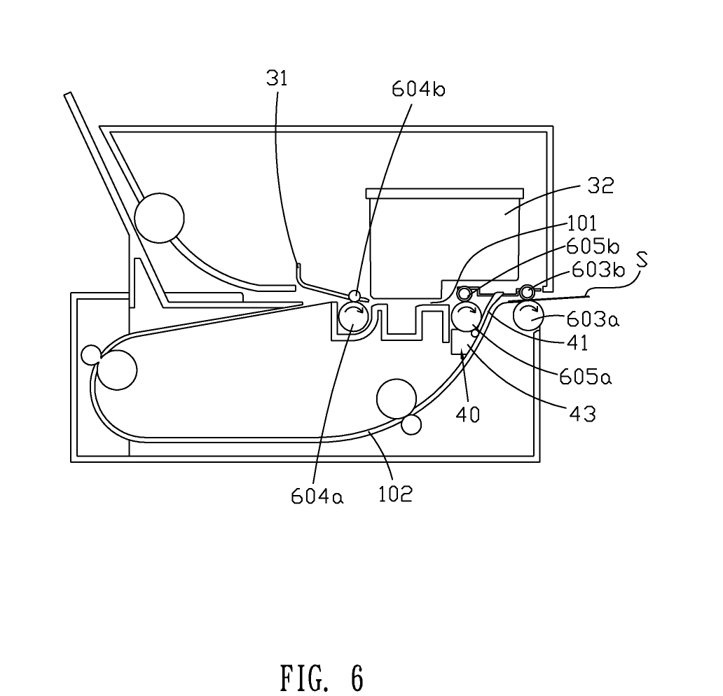

First referring to FIG. 1, an inkjet printer 100 with double-side printing function according to the invention is shown. The inkjet printer 100 with double-side printing function comprises a base 10, a guided component 20 located in the base 10, and a cover 30 covered on the base 10 and the guided component 20. A first path 101 is formed between the base 10 and the cover 30 and between the guided component 20 and the cover 30. A first path entrance 103 is located in the end of the first path 101. A first path exit 104 is located in the front of the first path 101. A second path 102 is formed between the base 10 and the guided component 20. The second path 102 has a second path entrance 105 and a second path exit 106. The second path exit 106 is located on the back of the first path 101. The second path entrance 105 is placed on the front of the first path 101 as showing in FIGS. 1 and 6.

The base 10 has a shelf 11 located in the end of the base 10, an exit driving roller 603a is located on the top of the front of the base 10. The front of the shelf 11 passes through the first path entrance 103. The first path exit 104 is arranged nearby the exit driving roller 603a. Delivered driving rollers 601a, 602b and delivered driven rollers 601b, 602b are symmetrically arranged along the second path 102, the delivered driving rollers 601a, 602b are located in the base 10, the delivered driven rollers 601b, 602b are located in the guided component 20.

The guided component 20 has a printed driving roller 604a located nearby the second path exit 106 and the top of the back of the guided component 20. A redirecting driving roller 605a is located on the top of the front of the guided component 20 and nearby the second path entrance 105. A redirector 40 is located under the redirecting driving roller 605a.

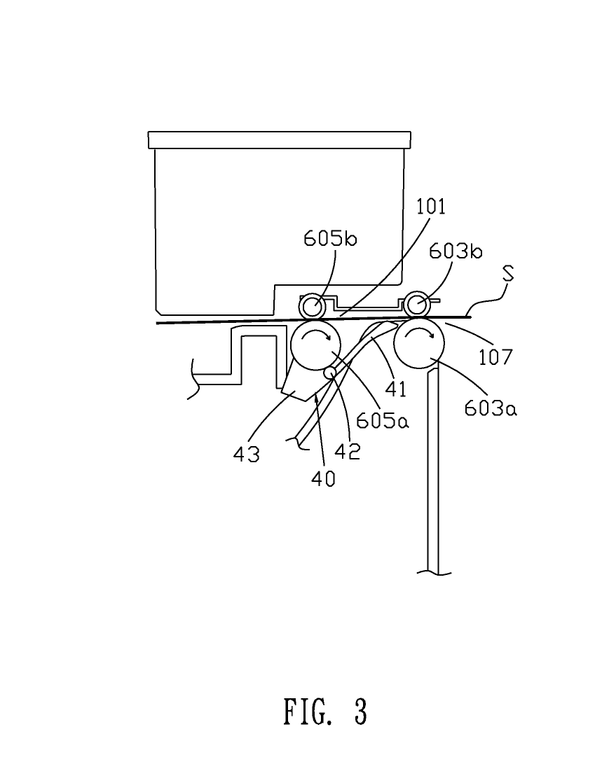

The redirector 40 includes a redirecting board 41, a rotated lump 43 and a rotated axle 42 connected the redirecting board 41 and the rotated lump 43. The rotated lump 43 is arranged under the redirecting driving roller 605a. The redirecting board 41 is arranged behind the second path entrance 105 and separates the first path 105, the second path 102 is connected. The lump 43 and the redirecting board 41 are combined firmly and may freely rotate around the rotated axle 42. In case the redirecting driven roller 605a is not driven by the redirecting driving roller 605b, the redirecting board 41 will close the first path 101 by the gravity of the lump 43. Furthermore, the redirecting board 41 will guide the paper into the second path 102 if needed. Once the paper is delivered out from the first path 101, the redirecting driving and driven rollers 605a, 605b will cause the redirecting board 41 to open the first path 101 for letting the paper be sent out. However, when the paper is delivered out completely but clamped by the rollers, the redirecting board 41 is moved to close the first path 101 and further guide the paper into the second path 102 for turning the paper to an opposite side. However, if the paper is turned to the opposite side already, the redirecting driven roller 605a will keep the redirecting board 41 to close the second path 102, against the gravity of the lump 43. In this case, the paper can be sent back to the first path 101 for printing the opposite side, as showing in FIGS. 3 to 6.

The cover 30 has an exit driven roller 603b, a printed driven roller 604b and a redirecting driven roller 605b, the exit driven roller 603b, the printed driven roller 604b and the redirecting driven roller 605b correspond to the exit driving roller 603a, the printed driving roller 604a and the redirecting driving roller 605a. A conducting element 31 is located in the cover 30 and arranged in the end of the redirecting driven roller 604b. A printing cartridge apparatus 32 is located in the cover 30 and arranged in the front of the redirecting driven roller 604b. The printing cartridge apparatus 32 has a print head 33, the print head 33 is arranged between the printed driven roller 604b and the redirecting driven roller 605b. A feeding roller 606a is located behind the cover 30 and correspond to the shelf 11 located in the base 10.

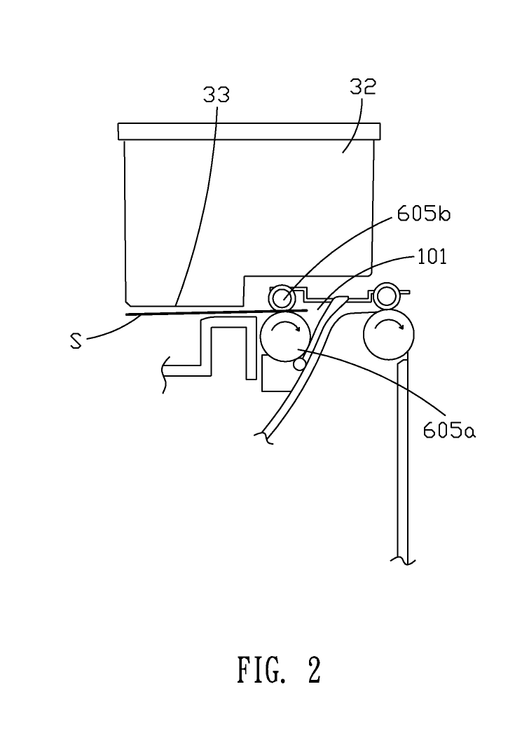

Please refer to FIGS. 1 and 2. While printing, the feeding roller 606a clockwise rotating, papers S deposited on the shelf 11 are delivered into the first path 101 one by one by the feeding roller 606a. The paper S is delivered into the first path entrance 103 and through between the printed driving roller 604a and the printed driven roller 604b by the conducting element 31. The printed driving roller 604a clockwise rotated and the printed driven 604b anticlockwise rotated, the paper S is forward delivered along the first path 101, while the paper S is delivered under the printing cartridge apparatus 32, the print head 33 prints the facade of the paper S. Furthermore, the redirecting driving roller 605a and the redirecting driven roller 605b rotate and the paper S is forward delivered along the first path 101 sequentially.

Referring to FIG. 3, the redirecting driving roller 605a clockwise rotates and the redirecting driven roller 605b anticlockwise rotates, the paper S is forward delivered along the first path 101. The paper S pushes forward the redirecting board 41 of the redirector 40, the redirecting board 41 clockwise rotated around the rotated axle 42, and the first path 101 is connected. A paper exit 107 is arranged in the front of the exit driving roller 603a and the exit driven roller 603b, while the paper S is delivered into the exit driving roller 603a, the exit driving roller 603a and the exit driven roller 603b rotated and delivered the paper S into the paper exit 107.

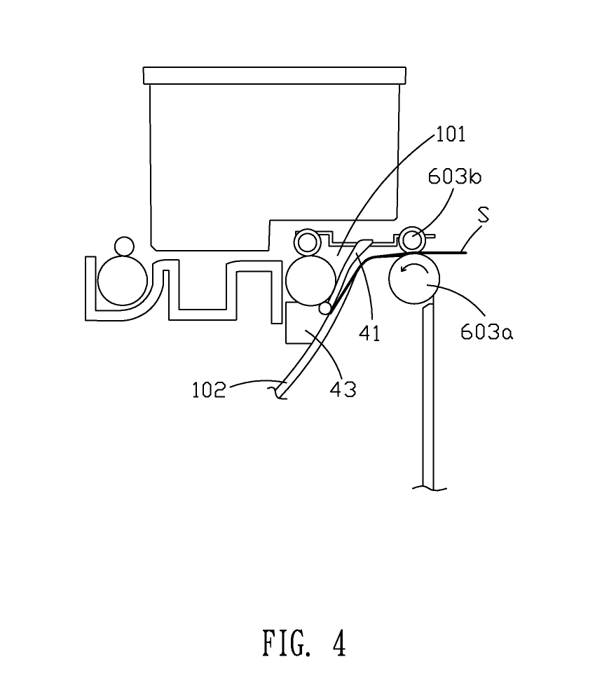

Please refer to FIG. 4, the facade of the paper S is entirely printed, and the paper S is entirely through the redirecting board 41. For the gravity of the rotated lump 43, the rotated lump 43 anticlockwise rotated, the redirecting board 41 is driven by the rotated lump 43 and returned to separate the first path 101 against. The front of the paper S is clamped between the exit driving roller 603a and the exit driven roller 603b, and the end of the paper S is near to the second path entrance 105. When the paper S is needed to print the opposite side of the paper S, the exit driving roller 603a is anticlockwise rotated, the exit driven roller 603b is clockwise rotated, the paper S is delivered reversely along the first path 101. Since the first path 101 is separated by the redirecting board 41, the paper S is delivered into the second path 102.

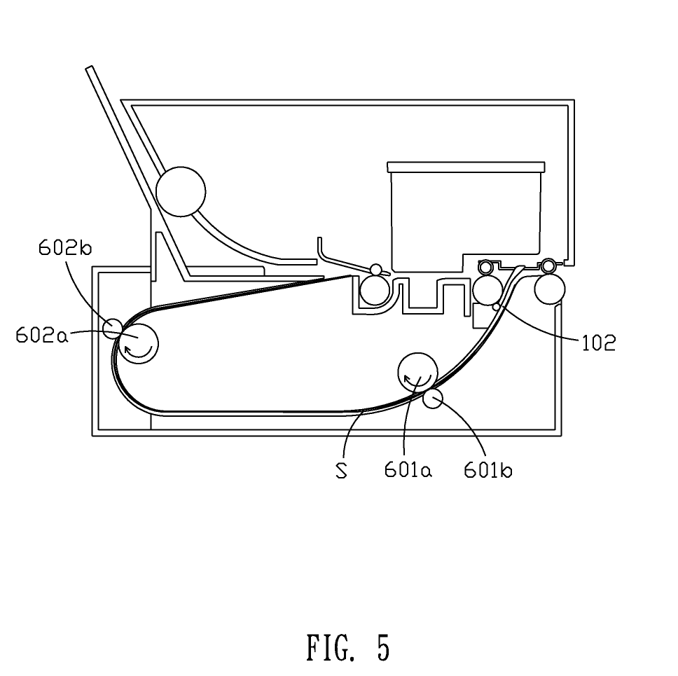

Referring to FIG. 5, the delivered driving rollers 601a, 602a arranged along the second path 102 clockwise rotate, the delivered driven rollers 601b, 602b arranged along the second path 102 anticlockwise rotate, the paper S is delivered along the second path 102.

Please refer to FIGS. 2-6, the paper S is delivered through the second path 102 into the first path 101, the paper S is upturned. After that the paper S is delivered and passes through between the printed driving roller 604a and the printed driven roller 604b. The printed driving roller 604a and the printed driven roller 604b deliver forward the paper S along the first path 101. While the paper S is delivered through the under of the printing cartridge apparatus 32, the print head 33 prints the opposite side of the paper S. The paper S pushes forward the redirecting board 41 of the redirector 40, and the first path 101 is connected. While the paper S is delivered nearby the exit driving roller 603a, the exit driving roller 603a and the exit driven roller 603b deliver the paper S out to the paper exit 107, so the two sides of the paper S is printed completely.

The second path entrance 105 is arranged in the front of the print head 33, so the facade of the paper S is printed entirely before the paper S delivered into the second path 102. The redirector 40 is not limited located in the guided component 20. Moreover, the redirector 40 may either be placed inside the cover 30 or as in base 10 as shown in the foregoing embodiment. The redirector 40 can be driven by the redirecting driving roller 605a.

An embodiment of the present invention has been discussed in detail. However, this embodiment is merely a specific example for clarifying the technical contents of the present invention and the present invention is not to be construed in a restricted sense as limited to this specific example. Thus, the spirit and scope of the present invention are limited only by the appended claims.

What is claimed is:

1. An inkjet printer with double-side printing function comprising:
a base having a shelf located in the top of the end of the base and an exit driving roller located in the top of the front of the base;
a guided component located in the base, a second path formed between the base and the guided component, delivered driving rollers and delivered driven rollers arranged along the second path, a printed driving roller located on the top of the guided component, the second path having a second path entrance in the front of the second path and a second path exit in the end of the second path; and
a cover covered on the base and the guided component, a first path formed between the base and the cover and between the guided component and the cover, the first path having a first path entrance in the end of the first path and a first path exit in the front of the first path, the first path entrance passes through the front of the shelf on the base, the first path exit located nearby the outside of the exit driving roller, the second path exit and the second path entrance passed through the front and the end of the first path, a printer apparatus located in the cover, the printer apparatus having a print head, a feeding roller located in the end of the cover and corresponding to the shelf, a printed driven roller located in the cover and corresponding to the printed driving roller in the guided component, an exit driven roller located in the cover and corresponding to the exit driving roller in the guided component,
wherein a printer apparatus located between the printed driving roller and the second path entrance, and
wherein a redirector arranged nearby the second path entrance, the redirector comprising a redirecting board, a rotated lump and a rotated axle connected the redirecting board and the rotated lump, while the redirecting board rotated clockwise, the rotated lump rotated clockwise around the rotated axle, the first path connected, while the rotated lump rotated anticlockwise, the redirecting board rotated anticlockwise, the first path be separated.

2. The inkjet printer with double-side printing function as set forth in claim 1, further comprising a redirecting driving roller located in the top of the front of the guided component and nearby the second path entrance, a redirecting driven roller located in the cover and corresponding to the redirecting driving roller.

3. The inkjet printer with double-side printing function as set forth in claim 1, further comprising a conducting element located in the cover and behind the printed driven roller.

4. The inkjet printer with double-side printing function as set forth in claim 1, wherein the redirector located in the guided component and nearby the second path entrance, the redirector can connect or separate the first path.

5. The inkjet printer with double-side printing function as set forth in claim 4, wherein said the redirector is located in the top of the front of the guided component and nearby the second path entrance.

6. The inkjet printer with double-side printing function as set forth in claim 5, wherein said the redirector is located in the cover and nearby the second path entrance.
